(19) United States
(12) Patent Application Publication
(10) Pub. No.: US 2004/0154024 A1
(43) Pub. Date: Aug. 5, 2004

(54) Component based user self-definition event mechanism

(76) Inventors: Rong Chen, Shanghai (CN); Yuzhou Liang, Shanghai (CN); Zhongqiang Ye, Shanghai (CN)

Correspondence Address: RABIN & BERDO, P.C., Suite 600, 1101 14th Street, N.W., Washington, DC, 20005, US

(21) Appl. No.: 10/747,243

(22) Filed: Dec. 30, 2003

(30) Foreign Application Priority Data
Dec. 31, 2002 (CN) 02159473.2

(51) Int. Cl. G06F 3/00

(52) U.S. Cl. 719/310

(57) ABSTRACT

A component based user self-definition event mechanism, including event manage part and event dispatch part; the connectable object is set in event dispatch part and the object event is dispatched; the event manage part realizes the storing of event processing function pointer, connecting with source object terminal and function invoking back, the event manage part and event dispatch part is related through the interface, it includes at least the user-defined interface register, realize the event processing function, and notify the function pointer to the event dispatch part object by registering, the object excites the event when the condition is met and invokes back the event processing function, the class intellectual pointer is utilized as the interface invoking pointer. Present invention generates component automatically, it has abilities of independent component upstage, easy and fast component co-operation, the realization of COM client program is greatly simplified.

### FIELD OF THE INVENTION

The present invention relates to a event manage mechanism and device in computer operation environment, especially relates to a user self-definition based user self-definition event mechanism of realizing the co-communication between client and component and on basis of component. The present invention belongs to the computer technology field.

### BACKGROUND OF THE INVENTION

In C++ programming model, for object oriented programming, the object couldn't be disassembled after linked, the stack couldn't packages the object, therefore has no flexibility. In component technology structure, the application program access the component through interface pointer.

In present technology, the communication course between client and component is in unidirectional way, the component may be replaced dynamically. The client creates component object, then the client invokes the interface function provided by object, in this interactive course, client is always active, but component object is in passive state. For a overall interactive course, this unidirectional communication couldn't meet the practical requirements.

The connectable object technology provided by Mirosoft Co could realize the invoking from component to client. However in this technology, the user is required to realize the connection between client program and component object, and also the event exciting and receiver compiling etc. And the register is only based on interface unit, i.e. it couldn't register respectively for each element function in interface. Moreover the Windows application programs must have a message circulation to process the message transferred from the Windows in message queue. In this way, each application program has a thread for waiting message and the more programs running at same time would occupy more resource.

The COM technology resolves mainly the following problems: the components from various sources realize a co-operation, component upstage doesn't affect other component, independent from the programming language, transparent operation of component within process, over-process or even over-network.

### BRIEF DESCRIPTION OF THE INVENTION

The main purpose of present invention is providing a component based user self-definition event mechanism, it could realize a co-operation between component terminal and client terminal, component development, operation environment and component library over-platform.

Another purpose of present invention is providing a component based user self-definition event mechanism, it could generate automatically in operation system the middleware (proxy component), provide the component location, invoking, managing, middleware starting & generating, component communicating function of within process, over-process and over-network.

Another purpose of present invention is providing a component based user self-definition event mechanism, it could guarantee the software co-operation and version independent upstage, it has the abilities of operation environment transparency, software co-development, software error tolerant, reliability, software re-using and version upstage.

Another purpose of present invention is providing a component based user self-definition event mechanism, it has abilities of independent component upstage, easy and fast component co-operation, interface re-used, local/remote transparency, independent programming language.

Another purpose of present invention is providing a component based user self-definition event mechanism, it realizes automatically the standard interface class package layer, the complicated detail of COM component object invoking is covered, the realization of COM client program is greatly simplified.

The purposes of present invention are realized through the following technologies: a component based user self-definition event mechanism, including event manage part and event dispatch part, two parts are co-related through interface; the event dispatch part structures the connectable object event by different parameters, the connectable object event has interface, the user self-definition event function is registered through interface, a receiver is created in event manage part, the event function pointer is packeted in the receiver of event manage part, the receiver has interface, and could be connected with the connectable object terminal by registering, the connectable object interface pointer is written in the relative receiver, and the interface pointer provided by receiver containing event processing function pointer is set in the corresponding connectable object, when the condition is met, the event dispatch part excites event, the event manage part invokes back the function through receiver interface, opens the packet and executes program.

In concrete, event dispatch part sets the event identification in connectable object event, the receiver of event manage part searches the event identification through interface, and obtains the connection interface pointer of the event connecting point object. The first parameter in event processing function parameter includes the class intellectual pointer of the event interface, and is for identifying event dispatch party; the second and hereafter parameters have same event parameter definition as the component definition. The interfaces include general interface and event interface, the general interface is a entry interface for providing service to client terminal, the event interface is a exit interface for invoking back the event processing function registered by client terminal when event occurs, the object communicates with client through event interface, each interface has a unique identifier, when the new function is added in component, the new interface description is defined first.

In event exciting, the system would invoke each event processing function according to the register order of event processing function.

Moreover, for the registered event, it may be canceled if doesn't needed, and the connection of event processing function corresponding to the connectable object event is canceled, in concrete, the receiver interface pointer in connectable object is canceled, and the receiver object is deleted (there aren't the event processing function pointer and connectable object pointer kept in it any more).

In order to realize one versus more or more versus one, more than one connectable object events are set in event dispatch part, each event corresponds to a connectable object; more than one receivers may be created in event manage part.

In order to register a same event process function into the different object event, the event manage part receiver may relates with more than one connectable objects; the event dispatch part connectable object may relates with more than one event manage part receivers, it may registers the more event processing functions corresponding to the same event, i.e. one event may corresponds to more event processing functions for executing respectively the different register request of same event.

In order to better manage the connectable object state, the re-load process is set in connectable object for “on or off” of state in which the connectable object is able to be invoked, it manages if the connectable object could be invoked.

Further, the re-load process is invoked when event manage part registers a connectable object in first time, i.e. set the invoke state of connectable object to “on”; the re-load process is invoked when event manage part cancels finally the connectable object, and set the invoke state of connectable object to “off”; execute idle operation when no re-load processing.

In concrete, the connectable object sets connection counter for counting up the connection quantity created by the connectable object, for each register, the counter adds “1”; for each canceling, the counter decreases “1”. The re-load process is invoked when the counter reading is zero, and the invoking state of connectable object is set to “off”.

Interface pointer container is set in event dispatch part for storing the description information of connectable object event and interface pointer, in the receiver registering within event manage part, the required connectable object event is searched through interface pointer container. The concrete search mode is an enumerative mode, in which, the event identification is searched one by one, the re-connection pointer transfers in the event identification corresponding to concrete event, and the connection interface pointer of the event connection point object is obtained.

The event manage part has manage interface connected with the application program for receiving the invoking application program of application program, the pointer of event processing function is transferred to event manage part through the interface, the event manage part then registers the event processing function, this is because that the codes of register and revoke back in event manage part are generated automatically, and the interface is needed to co-interactive with application program.

In present invention, the client terminal may be the event manage part or event dispatch part; the corresponding component terminal is event dispatch part or event manage part.

Present invention may be utilized in operation system; It is utilized in graphic system. Only when event occurs, the system invokes back the event processing function of user program and doesn't need message circulation. The user process may has no thread; the-operation system starts the thread when a event occurs and executes the event processing function.

Present invention is utilized also in driving program. The user program or operation system registers the event processing function into the device driving program component compiled with event mechanism, the driving program invokes back directly the user program or event processing function of operation system in hardware disconnecting.

As mentioned above, present invention realizes a component develop and operate environment of over-platform, safety, reliable, good error tolerant, compact, high efficient, the operation system supports component improving property, simple and flexible.

The present invention is applied in graphic system, the operation system invokes back the event processing function of user program only if a event occurs, and the message circulation isn't be required. The user process may has no thread, the operation system re-start the thread to execute event processing function when a event occurs, and the efficiency of operation system is greatly increased.

The present invention is applied also in driving system. The user program or operation system registers the event processing function into the device driving program component compiled with event mechanism, the driving program invokes back directly the user program or event processing function of operation system in hardware disconnecting. Thus the resource needed to inquire periodically the device state with thread may be saved, and the program compiling is more easily.

### BRIEF DESCRIPTION OF THE APPENDED DRAWINGS

FIG. 1 is an illustrative view showing a system in present invention.

FIG. 2 is an illustrative view showing the system structure corresponding to more component terminals from a client terminal.

FIG. 3 is an illustrative view showing the system structure corresponding to one component terminal from more client terminals.

FIG. 4 is a flowchart showing the register method in present invention.

FIG. 5 is a flowchart showing the exciting method in present invention.

FIG. 6 is a flowchart showing the cancel method in present invention.

FIG. 7 is an illustrative view showing a better embodiment in present invention—word quiz set.

FIG. 8 is an illustrative view showing a better embodiment in present invention—word quiz exciting program.

FIG. 9 is an illustrative view showing the course of registering, exciting and canceling.

### DETAILED DESCRIPTION OF THE INVENTION

Next, a further description will be made as to the present invention with the Figures and concrete embodiment.

In self-defining event mechanism in present invention, the courses of event dispatching, function pointer keeping, linking with source object terminal and invoking back function etc are completed. In component program compiling, user needs only to care about when to excite event, in compiling the client terminal program, user needs only to register the event processing function in suitable time. Other works, such as event dispatching and invoking back event processing function etc are all completed by present invention. Thus it is easy to compile the components with event interface and the program of client terminal utilizing the component.

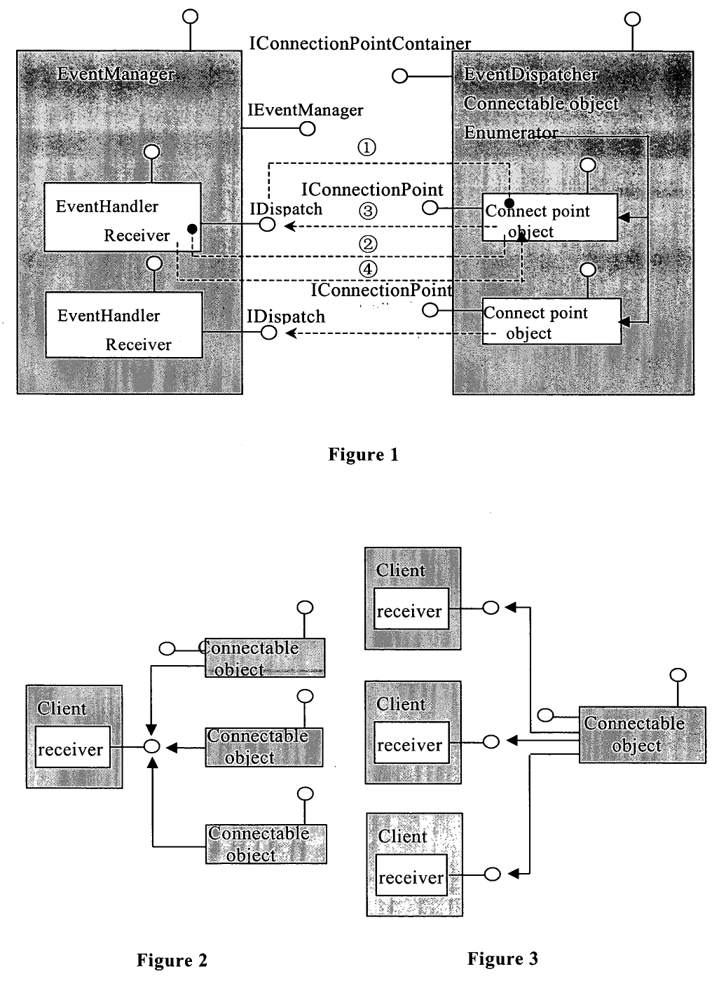

As FIG. 1 shows, present invention includes event manage part-client terminal and event dispatch part-component terminal. The event dispatch part dispatches the event, event manage part realizes the keeping of event processing function pointer, connecting with original object terminal, invoking back function, two parts communicate via interface, the communication itself includes at least the step of user self-defining interface register, excite event according to register information, and step-of canceling for canceling the event processing function.

The client terminal may be a event manage part or event dispatch part; the corresponding component terminal is event dispatch part or event manage part.

Each event corresponds to a connection point.

As FIG. 1 shows, the connection point object records the interface pointer of receiver containing the registered event processing function pointer. ?: in event registering, keeps the IDispatch interface pointer to the connection point object;?: in event registering, keeps the dwCookie identifying this connection to the EventHandler;?: in event exciting, invoke its Invoke method with the kept IDispatch interface pointer;? cancel the event by the dwCookie kept by EventHandler.

One event may corresponds more event processing functions for executing respectively the different register request of same event. The event processing function parameter stipulation is: the first parameter must include the class intellectual pointer of the event interface for indicating the event dispatch part; the second and hereafter parameters have same event parameter definition as the component definition.

The event processing function includes also re-load function for “on or off” of state in which the connectable object may be invoked, it manages if the connectable object could be invoked. It is invoked only if a event is registered in client terminal for fist time; and it is invoked only if a event is canceled in client terminal for last time, execute idle operation when no re-load processing.

The event manage part sets more than one receivers of independent respectively for interface connection. The event manage part has event manage interface for creating or releasing the event processing object. In the event processing object releasing, the event processing function pointer is stored, and the dispatch interface of event manage part receiver is provided; the event dispatch part includes more than one connectable objects; the receiver connects with connectable object by setting and interface. Event dispatch part transfers in the event identification corresponding to concrete event through searching the connection pointer, and obtains the connection interface pointer of the event connection point.

The event dispatch part event connection point object is connected through dispatch interface connecting the interface pointer and event manage part receiver and communicates. The event dispatch part has also connecting pointer container for searching the relative connecting point by event identification.

Refer to FIG. 2, the event manage part receiver in present invention may relates with more than one connectable objects as a client terminal; or as FIG. 3 shows, event dispatch part connectable object may relates with more than one event manage part receivers. Thus a same event processing function may be registered to different object event; a same event may has more event processing functions to be registered into them.

Concretely, the interfaces include general interface and event interface, the general interface is a entry interface for providing service to client terminal, the event interface is a exit interface for invoking back the event processing function registered by client terminal in event occurs, the object communicates with client through event interface. A component terminal may has an or more general & event interfaces. Each interface has a unique identifier, when the new function is added in component, the new interface description is defined first.

The intellectual pointer is utilized in component object creating, general interface invoking & registering, event canceling.

When a client program needs a event processing function to response to the event, the event processing function is needed to be registered; When a client program doesn't need a event processing function to response to the event, the event processing function may be canceled. In event exciting, the system would invokes each event processing function in accordance with the event processing function register order.

The event dispatch part is a connectable object. Each event corresponds with a connect point object. The event dispatching provides the connection pointer container interface. Through the FindconnectionPoint function of the interface and transferring in the event identification corresponding to the concrete event, the connect point interface pointer of the event connect point object may be obtained.

The event manage part provides the event manage part interface, the event processor object may be created or released through this interface. The event processor object keeps the event processing function pointer and provides the manager part interface.

If a object in present invention supports a or more event interfaces, the object is called connectable object, sometimes called source object. Each element function in event interface represents an event. When a special event occurs, e.g. a timing message or a user mouse operation, the component object generates a event, and the client program may process the event. The element function of event interface in component object is not realized by object, but by client program. The client program realizes the event processing functions, and notify the component object about the function pointer through registering, and the object excites the event and invokes back the event processing function suitable condition.

The obtaining of legal intellectual pointer is like: created by component class operation, or initialized by legal intellectual pointer, or assigned by legal intellectual pointer.

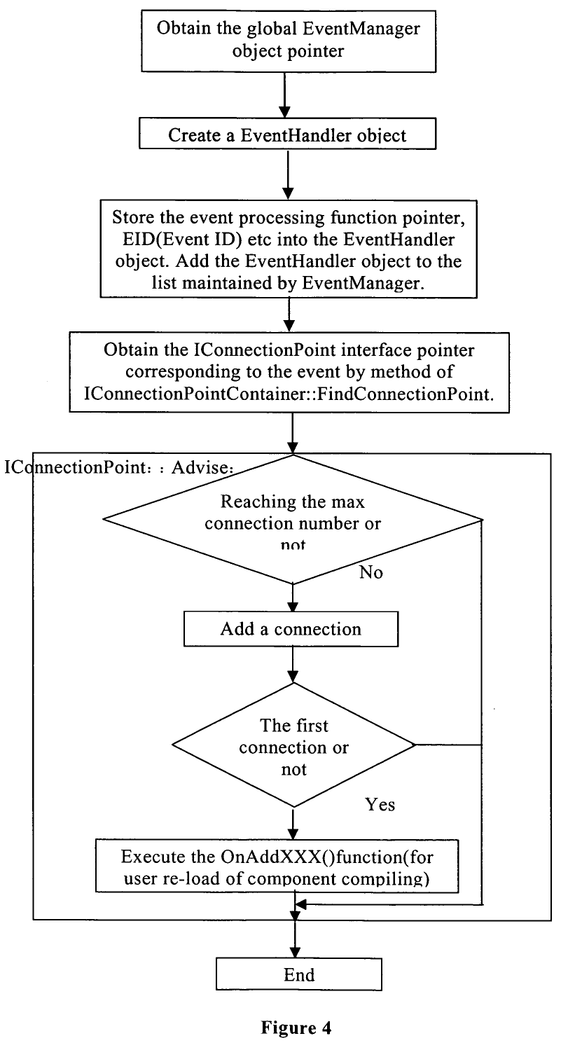

Concretely, as FIG. 4 shows, the client register event processing function in present invention would complete the following operations:

Step 1: obtain the event manage part interface pointer;

Step 2: create the receiver object (EventHandler) through event manage part interface, and store the pointer of event processing function to the object;

Step 3: find out the connect point object corresponding to the event by the search connection pointer in connect point container interface provided by source object;

Step 4: register the event manage part interface provided by event receiver to the source object terminal through the Advise function in connect point pointer interface provided by connect object;

Step 5: obtain the dwCookie identifying the connection in registering and store it in receiver object.

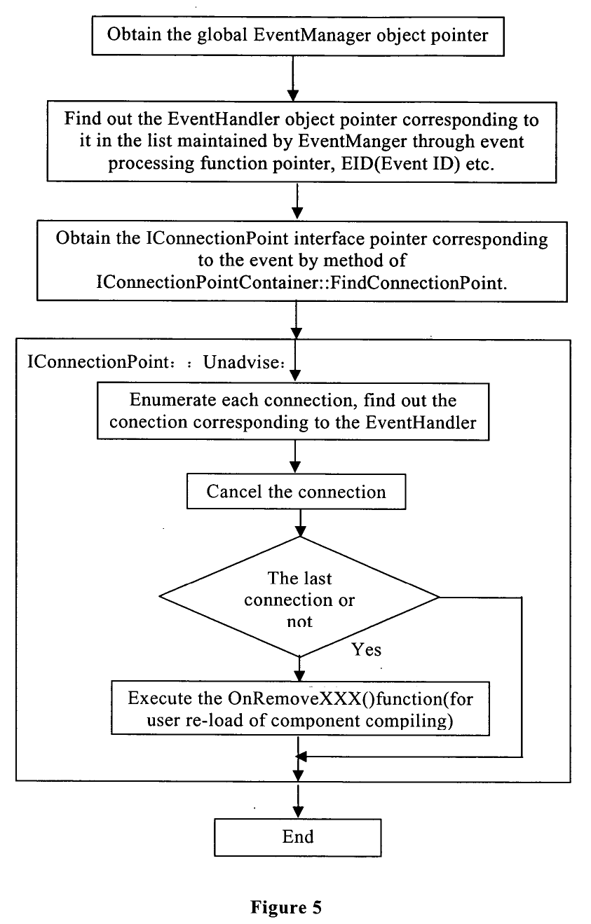

As FIG. 5 shows, the component exciting event would completes the following operations:

Step 1: enumerate each connection in connect object corresponding to the event;

Step 2: packet the event parameter, and invoke the Invoke function in the IDspatch to each connection and excite the event;

Step 3: the receiver object un-packet the transferred Invoke parameter, and invoke the event processing function through the stored function pointer.

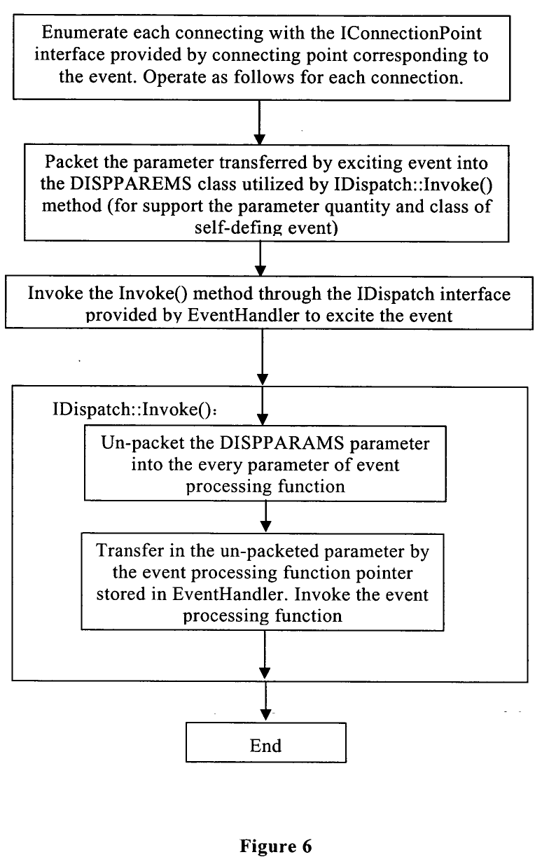

As FIG. 6 shows, the client canceling event processing function would completes the following operations:

Step 1; find out the corresponding receiver object through event processing function pointer and event EID(Event ID event identification);

Step 2: obtain the dwCookie identifying the connection stored in receiver object;

Step 3: find out the connect point object corresponding to the event by the FindConnectionPoint function in IConnectionPointContainer provided by source object;

Step 4: transfer in the dwCookie as a parameter by the Unadvise function in IconnectionPoint interface provided by connect point object, and cancel the IDispatch interface provided by event processor;

Step 5: release the receiver object.

### CONCRETE EMBODIMENT 1

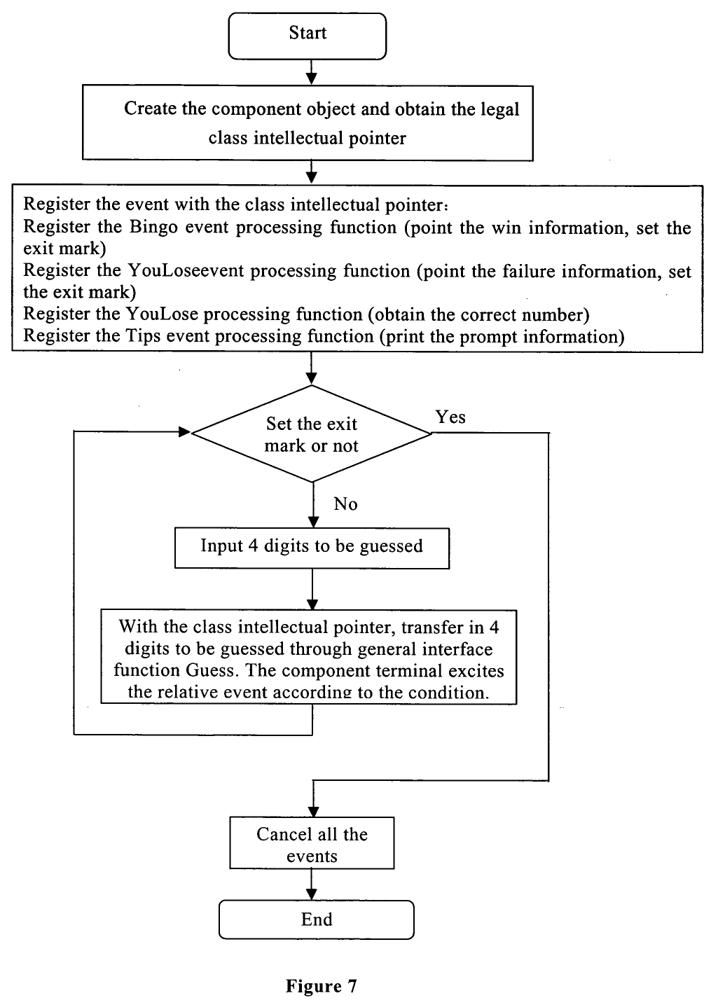

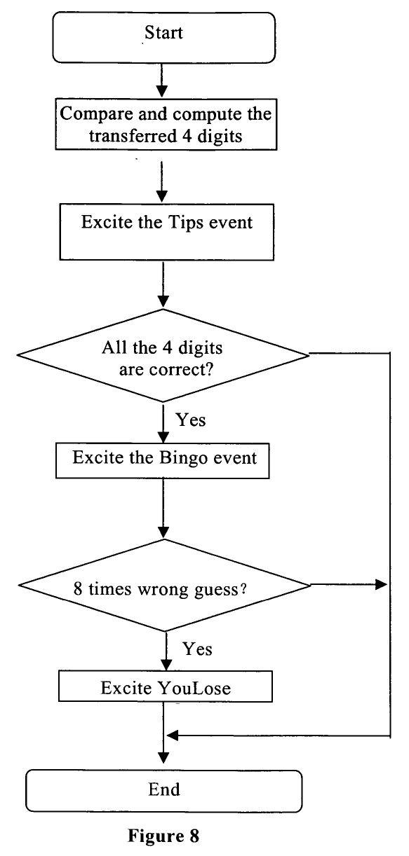

Refer to FIG. 7, 8, take the course of creating and managing a number quiz program as a example.

Create the component object, and obtain the legal class intellectual pointer. Register with this pointer. The event designs to print the win information, set the exit mark; print the failure information, set the exit mark; obtain the correct number, print the prompt information. So it needs the program to be registered in component terminal.

Generate a soured file, a or more head files and CPP file, and make corresponding to a head files and a CPP file.

Obtain four numbers; guess the number, judge the result, excite event, guess the number state per time, and record the guess times.

In component programming, it needs only to invoke the method to excite event.

In number guess quiz, after guess result judgment, excite TIP event, and dispatch the number guess information to the client terminal.

In correct guessing, excite BINGO event, and in wrong guessing, excite YOULOSE event.

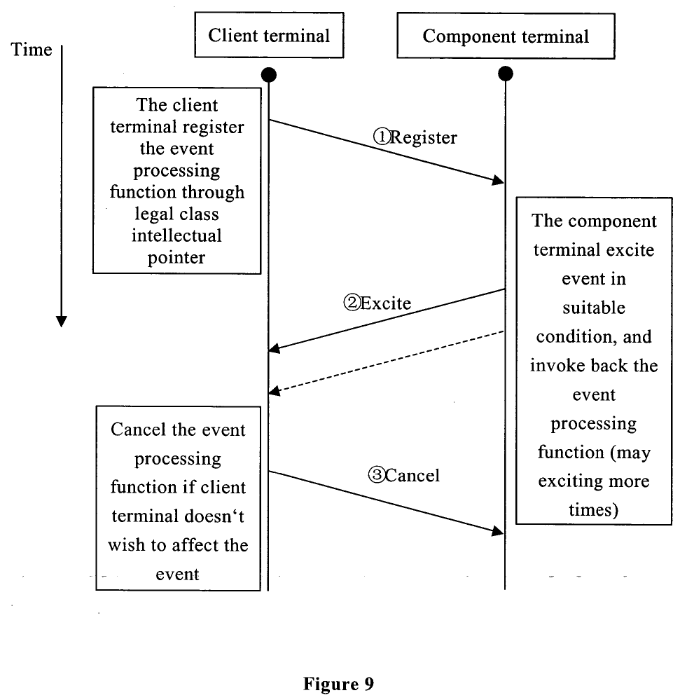

The general flow in present invention is as FIG. 9:

Step 1: the client terminal creates the component object, and obtains the legal class intellectual pointer, and register the event processing function to component terminal by the class intellectual pointer;

Step 2: The component terminal excite the event in suitable condition, such as timing message or user mouse operation occurs, and invoke back the event processing function registered in step 1, the event may be invoked more times;

Step 3: When client terminal doesn't wish to response the event, the event processing function registered in step 1 is canceled through the class intellectual pointer.

We claim:

1. A component based user self-definition event mechanism, characterized in that:
Including event manage part and event dispatch part, two parts are co-related through interface; the event dispatch part structures the connectable object event by different parameters, the connectable object event has interface, the user self-definition event function is registered through interface, a receiver is created in event manage part, the event function pointer is packeted in the receiver of event manage part, the receiver has interface, and could be connected with the connectable object terminal by registering, the connectable object interface pointer is written in the relative receiver, and the interface pointer provided by receiver containing event processing function pointer is set in the corresponding connectable object, and is used for event exciting, when the condition is met, the event dispatch part excites event, the event manage part invokes back the function through receiver interface, opens the packet and executes program.

2. A component based user self-definition event mechanism according to claim 1, characterized in that:
Event dispatch part sets the event identification in connectable object event, the receiver of event manage part searches the event identification through interface, and obtains the connection interface pointer of the event connecting point object.

3. A component based user self-definition event mechanism according to claim 1, characterized in that:
For the registered event, it may be canceled if doesn't needed, and the connection of event processing function corresponding to the connectable object event is canceled, in concrete, event manage part cancels the event through the connectable object interface pointer kept in receiver corresponding to event processing function.

4. A component based user self-definition event mechanism according to claim 1, characterized in that:
The first parameter in event processing function parameter includes the class intellectual pointer of the event interface, and is for identifying event dispatch party; the second and hereafter parameters have same event parameter definition as the component definition.

5. A component based user self-definition event mechanism according to claim 1, characterized in that:
The interfaces include general interface and event interface, the general interface is a entry interface for providing service to client terminal, the event interface is a exit interface for invoking back the event processing function registered by client terminal when event occurs, the object communicates with client through event interface.

6. A component based user self-definition event mechanism according to claim 11, characterized in that:
Each interface has a unique identifier, when the new function is added in component, the new interface description is defined first.

7. A component based user self-definition event mechanism according to claim 1, characterized in that:
In event exciting, the system would invoke each event processing function according to the register order of event processing function.

8. A component based user self-definition event mechanism according to claim 1, characterized in that:
More than one connectable object events are set in event dispatch part, each event corresponds to a connectable object.

9. A component based user self-definition event mechanism according to claim 1, characterized in that:
More than one receivers may be created in event manage part.

10. A component based user self-definition event mechanism according to claim 9, characterized in that:
The event manage part receiver may relates with more than one connectable objects for registering the same event processing function into the different object event.

11. A component based user self-definition event mechanism according to claim 9, characterized in that:
The event dispatch part connectable object may relates with more than one event manage part receivers for registering the more event processing functions corresponding to the same event, i.e. one event may corresponds to more event processing functions for executing respectively the different register request of same event.

12. A component based user self-definition event mechanism according to claim 9, characterized in that:
The re-load process is set in connectable object for “on or off” of state in which the connectable object is able to be invoked, it manages if the connectable object could be invoked.

13. A component based user self-definition event mechanism according to claim 12, characterized in that:
The re-load process is invoked when event manage part registers a connectable object in first time, i.e. set the invoke state of connectable object to “on”; the re-load process is invoked when event manage part cancels finally the connectable object, and set the invoke state of connectable object to “off”; execute idle operation when no re-load processing.

14. A component based user self-definition event mechanism according to claim 13, characterized in that:
The connectable object sets connection counter for counting up the connection quantity created by the connectable object, for each register, the counter adds “1”; for each canceling, the counter decreases “1”.

15. A component based user self-definition event mechanism according to claim 14, characterized in that:
The re-load process is invoked when the counter reading is zero, and the invoking state of connectable object is set to “off”.

16. A component based user self-definition event mechanism according to claim 1, characterized in that:
Interface pointer container is set in event dispatch part for storing the description information of connectable object event and interface pointer, in the receiver registering within event manage part, the required connectable object event is searched through interface pointer container.

17. A component based user self-definition event mechanism according to claim 16, characterized in that:
The search mode is an enumerative mode, in which, the event identification is searched one by one, the re-connection pointer transfers in the event identification corresponding to concrete event, and the connection interface pointer of the event connection point object is obtained.

18. A component based user self-definition event mechanism according to claim 1, characterized in that:
The event manage part has manage interface connected with the application program for receiving the invoking application program of application program, the pointer of event processing function is transferred to event manage part through the interface, the event manage part then registers the event processing function.

19. A component based user self-definition event mechanism according to claim 18, characterized in that:
The client terminal may be a event manage part or event dispatch part; the corresponding component terminal is event dispatch part or event manage part.

20. A component based user self-definition event mechanism according to claim 18, characterized in that:
It is utilized in operation system.

21. A component based user self-definition event mechanism according to claim 18, characterized in that:
It is utilized in graphic system.

22. A component based user self-definition event mechanism according to claim 21, characterized in that:
Only when event occurs, the system invokes back the event processing function of user program and doesn't need message circulation.

23. A component based user self-definition event mechanism according to claim 22, characterized in that:
The user process may has no thread, the operation system starts the thread when a event occurs and executes the event processing function.

24. A component based user self-definition event mechanism according to claim 23, characterized in that:
It is utilized in driving program.

25. A component based user self-definition event mechanism according to claim 24, characterized in that:
The user program or operation system registers the event processing function into the device driving program component compiled with event mechanism, the driving program invokes back directly the user program or event processing function of operation system in hardware disconnecting.
